(19) United States
(12) Patent Application Publication
(10) Pub. No.: US 2008/0106512 A1
(43) Pub. Date: May 8, 2008

(54) LIGHT SOURCE ARRANGEMENT FOR BACKLIGHTING DISPLAY DEVICES

(76) Inventor: Axel Schwab, Munich (DE)

Correspondence Address: FISH & RICHARDSON PC, P.O. BOX 1022, MINNEAPOLIS, MN, 55440-1022, US

(21) Appl. No.: 11/877,959

(22) Filed: Oct. 24, 2007

Related U.S. Application Data
(63) Continuation of application No. PCT/DE2006/000739, filed on Apr. 27, 2006.

(30) Foreign Application Priority Data
Apr. 30, 2005 (DE) 10 2005 020 568.2

(51) Int. Cl. G09G 3/36

(52) U.S. Cl. 345/102

(57) ABSTRACT

A light source arrangement for backlighting a display device, comprising a plurality of light sources and a controller that adjusts the luminous intensity of the light sources to the information to be reproduced, and a display device including said light source arrangement.

### CROSS-REFERENCE TO RELATED APPLICATIONS

This application is a continuation of and claims the benefit of priority of International Application No. PCT/DE2006/000739, filed Apr. 27, 2006, which claims priority to German Patent Application Serial No. 10 2005 020 568.2, filed Apr. 30, 2005. The contents of the prior applications are hereby incorporated by reference in their entirety.

### TECHNICAL FIELD

This disclosure relates to a light source arrangement for backlighting display devices.

### BACKGROUND

As part of the generally growing demand for ever-flatter display devices, the demand for LCD (liquid crystal display) devices and LCD screens and for TFT (thin film transistor) display devices and TFT screens has been increasing at a faster pace. Like plasma screens, LCD and TFT screens have the advantage over conventional tube units of being of flat construction. LCD and TFT screens also have longer life and lower power consumption than plasma screens.

The background lighting of LCD and TFT screens heretofore was usually done with cold cathode fluorescent lamps (CCFL). Recently, however, the use of semiconductor light sources to backlight screens of this kind has been steadily gaining prominence. For example, the document US 2002/0070914 A1 describes a background lighting system for an LCD display comprising a field of light-emitting diodes.

LCT and TFT screens, however, are barred from more widespread use by their low contrast ratios, of about 800:1 with a luminance of 500 candela/m². Plasma sets, on the other hand, attain contrast ratios of 3000:1, accompanied by very high luminance levels of up to 1000 candela/m². The contrast values of conventional tube sets, by comparison, can be as high as 10,000:1. But such tube sets are not susceptible to flat construction.

A low contrast ratio is especially significant in the case of LCD or TFT screens, for example in television sets, for example if image sequences that include night scenes are to be displayed. Prior-art LCD or TFT screens are unable to display saturated or dark black because of their poor contrast ratios.

It is possible to increase the contrast ratios of LCD and TFT screens by improving the light valves that are installed in these types of screens to pass or block light. The aim in improving light valves is to increase their maximum filter attenuation. However, there are technical limits on how much the attenuation can be increased. When the background illumination of the display devices is strong and the filter attenuation limited, the contrast is also limited, causing black areas to show up dark gray.

### SUMMARY

Disclosed herein is a light source arrangement that improves the contrast ratios of display devices. A display device with an improved contrast ratio is also disclosed.

In one aspect, a light source arrangement for backlighting a display device is disclosed that comprises a plurality of light sources and a controller that adjusts the luminous intensity of individual light sources or of groups of light sources to the information that is to be reproduced. Luminous intensity is defined as an SI unit and is often referred to as light intensity or brightness.

Contrast enhancement—i.e., increasing the ratio of the brightness of the brightest pixel to the brightness of the darkest pixel—is achieved not only by using the effect of the light valves of a display device to produce contrast, but also by adjusting the luminous intensity of the appropriate light sources of the light source arrangement.

Light valves are elements that are controlled to pass or block light. In LCD displays, such valves contain liquid crystals that are able to polarize light by their alignment. In TFT displays, the light valves contain transistors.

The light source arrangement can be used particularly in LCD or TFT television sets, since the resolution of the television image is generally lower than the technically feasible resolution of the LCD or TFT image matrix. The range of contrast variations that has to be displayed in the region backlit by a light source is small.

The light sources used are preferably radiation-emitting semiconductor components such as light-emitting diodes (LEDs), including organic LEDs, or laser diodes. Alternatively, it is also possible to use other light sources that are capable of providing areal illumination and whose luminous intensity can be controlled individually or as a group.

An advantageous embodiment of the light source arrangement comprises one or more light guides to guide the light from the semiconductor light sources to the appropriate regions of the screen. A light guide is preferably disposed after each light source in the radiation direction in such a way that the bulk of the radiation extracted from the light source passes into the light guide.

Direct backlighting without the use of light guides is also possible, however. In direct backlighting, the radiation extracted from the light sources is preferably shaped by means of one or more beam-shaping elements. Beam-shaping elements are, for example, lenses, collimators and/or diffusers. The beam shaping is especially preferably executed in such a way that the region backlit by a light source is increased in size. Such beam-shaping elements are disposed after the light sources in the radiation direction in such a way that the bulk of the light extracted from a light source passes through a beam-shaping element.

In one advantageous embodiment, a light source is formed by a light group. A light group is the result of combining one or more radiation-emitting semiconductor components into a light source which, in an advantageous configuration, is itself implemented in turn as a separate component. Such a light group is formed, for example, by a multichip structure in which a plurality of radiation-emitting semiconductor chips are arranged in a common housing.

A light source preferably illuminates a defined region of the display device to be backlit, for example an LCD or TFT display device. An advantageous embodiment of the invention provides that a light source backlights a region in the display device that contains plural light valves.

This has the advantage that a light source handles the backlighting for a defined region of the light valve arrangement. In this way, larger-area illumination can be built up in modular fashion by means of light tiles.

The backlighting apparatus for a single region is known as a light tile. As a rule, a light tile backlights a plurality of pixels of a display device. In the case of rectangular light tiles, a light tile backlights a region composed of n·m pixels of the display device, m being equal to n in the particular case of square light tiles. The number of pixels of such a region is preferably directly proportional to the number of light valves in that region.

A light tile preferably backlights 4096 pixels, particularly preferably 1024 pixels, of a display device. Square light tiles therefore preferably illuminate a region of 64×64 pixels, particularly preferably of 32×32 pixels.

Light tiles for backlighting such a number of pixels are advantageously so small that the differences in contrast within a light tile are usually slight. In addition, the brightnesses of the regions backlit by adjacent light tiles often differ so minimally that adjacent light sources can be operated at similar luminous intensities when the light source arrangement is in operation. This advantageously results in finely graded, substantially uniform transitions between strongly and faintly backlit regions of the backlit display device. If the information to be reproduced is an image sequence, the brightness of the region of the display device backlit by a light tile often varies only slightly among consecutive images within the image sequence. Abrupt changes in the luminous intensity of a light tile thus are virtually prevented. Nonetheless, advantageously only a relatively small number of light sources compared to the number of pixels are needed to produce the backlighting.

A further advantageous embodiment provides that the adjustment of the luminous intensity of the individual light sources or groups of light sources is obtained by having the controller control the power supply to the individual light sources or groups of light sources. This is preferably done by supplying the light sources with a time-variant current, for example an analog current or a digitally clocked current. In the case of a clocked power supply, the current is delivered in individual pulses that can be modulated in various ways. For example, the luminous intensity of the light source is preferably varied by pulse width control, i.e., by changing the duration of a pulse while keeping the clock frequency the same; by frequency control, i.e. by changing the duration of a clock cycle particularly while the keeping the pulse duration the same; or by a combination of the two. For example, in the operation of a light source, lengthening the clock frequency while keeping the pulse duration the same creates in the observer an impression, on a time average, of lower brightness, since less energy on a time average is being supplied to the light source.

The clock frequency is, in any event, selected as so high that the human eye is not capable of separately resolving the individual light pulses so generated. The eye of the observer registers a reduced number of light pulses, which are no more resolvable individually than the reduced brightness of the light source. For example, the controller uses this effect to vary the luminous intensity perceived by the observer by means of a modulation such as pulse width control and/or frequency control. The pulse width control and/or frequency control is preferably executed with q-bit (qualifier bit) technology.

A further advantageous embodiment provides that the adjustment of the luminous intensity of the individual light sources or groups of light sources is obtained by changing the level of the operating current. A change in the amplitude of the current passing through a light source causes a change in the luminous intensity of the light source. A controller configured for this purpose therefore varies the intensity of the current supplied to the individual light sources or groups of light sources in order to adjust their luminous intensity.

An advantageous embodiment of the light source arrangement provides that the adjustment of the luminous intensity of the light sources is done by rows and/or by columns. An embodiment of this kind has the advantage that the controller need not drive all the light sources individually, but can access them by rows and/or columns. This simplifies control in this embodiment.

A further advantageous embodiment of the light source provides that the light sources are arranged in a regular grid, the arrangement being selected from the group consisting of rectangular, parallelogrammatic, hexagonal and rhombic grid arrangements.

For example, a rectangular grid arrangement permits especially simple control, since the light sources can then be controlled in a simple manner by rows and/or columns. In particular embodiments of the invention, however, it may be practical to choose another grid arrangement. For example, hexagonal grid arrangements generally permit denser packing of the individual light sources, and thus a higher overall luminous intensity.

A particularly advantageous embodiment provides that at least one diffuser is disposed after the light sources in the radiation direction in such a way that the bulk of the radiation extracted from the light sources passes into the diffuser. The use of such a diffuser results in a more uniform distribution of light on the to-be-backlit surface of the display device or information reproducing device.

A further advantageous embodiment of the light source arrangement provides that a homogenizing element (a white box element) is disposed after each light source in the radiation direction in such a way that the bulk of the radiation extracted from the light source passes into the homogenizing element. The homogenizing elements are particularly associated with backlit regions (pixel fields) of the display device. A white box element preferably includes a reflector that homogenizes the light radiated by the light source so that the area illuminated by the white box element preferably appears to the observer to be substantially equally bright at all points, and/or serves to perform beam shaping.

A white box element, a light guide and/or a combination of a light guide and a white box element improves the uniformity of the backlighting of a region of the display device that is being backlit by a light source. The homogenizing elements are preferably arranged such that there are no sharp bright/dark transitions between the light-producing regions, particularly individual light tiles.

A further preferred embodiment of the light source arrangement provides that at least one BEF (brightness enhancement film) is associated with the light sources. Such a BEF increases the radiation of light perpendicular to the display plane by focusing the radiation in the direction of the surface normal of the display plane. An observer seated directly in front of the display device therefore experiences its radiation as brighter if such a BEF is disposed after the light sources in the radiation direction.

A further advantageous embodiment of the light source arrangement provides that the light sources or light groups are arranged on a common carrier. Possible carriers can be all types of circuit boards, particularly metal-core circuit boards, which have an elevated thermal conductivity.

Light sources, particularly individual light sources or groups of light sources, that preferably backlight different regions of the display device are usefully operated by the controller at mutually different luminous intensities, particularly at the same times. Regions in which the information to be displayed should have a low brightness as perceived by the observer are thereby backlit at a lower luminous intensity, whereas regions in which the information to be displayed should have a higher brightness to the observer are backlit at a higher luminous intensity. For example, the ratio of the brightness of the brightest pixel to the brightness of the darkest pixel is advantageously increased in this way.

A particularly advantageous embodiment provides that the controller controls the luminous intensity of the light sources, particularly of individual light sources or groups of light sources. The controller thus automatically adjusts the luminous intensity of the light sources according to its algorithm. Contrast enhancement is achieved by means of the controller for controlling the luminous intensity of the individual light sources or groups of light sources for example by increasing the ratio of the brightness of the brightest pixel to the brightness of the darkest pixel. The controller uses an algorithm for the control. At least one of the following input variables is processed in this algorithm. These include:
the contrast values, that is, in particular, the normalized brightnesses of the pixels of information to be reproduced that are backlit by a light source (light tile), particularly the average of the brightnesses and/or the highest and lowest brightness of those pixels,
the contrast values of adjacent light tiles, particularly the average of the brightnesses and/or the highest and lowest brightness of a pixel of one, a plurality, or each of those light tiles,
the contrast values of all the information reproduced by the display device, i.e., for example, the brightness of the brightest pixel and the brightness of the darkest pixel, and/or
the brightness of the environment of the display device.

The brightnesses or contrast values of the pixels of information to be reproduced are preferably determined by the control unit from the signal carrying the information to be reproduced, which signal is stored in the display device.

The brightness of the environment is measured for example by a sensor, particularly an AL sensor (ambient light sensor). An ambient light sensor is a brightness sensor whose spectral sensitivity is preferably adjusted to that of the human eye.

The contrast values are in particular two-dimensional values. The controller thus preferably creates a matrix, particularly when the light sources are arranged in rows (the x-direction) and columns (the y-direction). The number of rows and columns in the matrix is preferably the same as those of the light sources, so each light source is associated with a cell of the matrix. The contrast values, for example the averaged brightnesses, of the pixels of information to be reproduced that are associated with the individual light sources are usefully entered in the cells of the matrix. The desired luminous intensity of the light tiles, for example taking the luminous intensity of the adjacent light tiles into account, can easily be determined by means of matrix operations.

Particularly in the case of the display of image sequences—films, for example—the controller is particularly preferably adapted to control the luminous intensity of the light sources, as an image in the image sequence is displayed, as a function of the brightness values or contrast values of one or more temporally preceding and/or succeeding images in the image sequence. In this case, the brightness values or contrast values are, for example, the contrast values of the pixels associated with a light tile, the contrast values of the pixels backlit by adjacent light sources, and/or the contrast values of the image as a whole, i.e., for example the brightness of the brightest pixel and the brightness of the darkest pixel. It is thereby possible to react even to rapid changes in contrast within a region of the display. For example, any flickering of light sources due to rapid changes in brightness within a light tile is suppressed. To display an image in the image sequence, preferably the brightness or contrast values of one or more previous images and, especially in the case of time-delayed displays, particularly preferably also the contrast values of one or more succeeding images are analyzed and used to effect control.

In a preferred embodiment, the controller additionally employs special algorithms for control. For example, an additional algorithm is used to detect superimposed subtitles during the playback of an image sequence, particularly a film. For example, when white lettering is superimposed on a dark, particularly black, background, high contrast differences are created in the region of the display device backlit by a light source. So that such extremely high contrast differences do not interfere with the contrast reproduction of the overall image information in the image sequence, for example the extremely high contrast of white lettering is varied by the controller by using a softened contrast, for example that of gray lettering.

Since the contrast values are basically normalized brightness values, in a useful embodiment the controller is configured such that instead of the contrast values, the related brightness values are processed as the input variables of the algorithms. The brightness values of the individual pixels are easy to determine if the information to be reproduced is in one of the standard coding schemes used for transmission to a display device, and can therefore be processed particularly simply by the controller.

In a further advantageous embodiment, the controller additionally controls the light valves, particularly to adjust the graphic resolution of the reproduced information. The controller thereby, for example, adjusts the resolution of the information to be reproduced to the raster of the light tiles. For example, the controller adjusts the resolution of to-be-displayed information in such a way that the edge of the display exactly coincides with edges of the light tiles of the backlighting arrangement.

In addition, control of this kind permits optimal exploitation of the individual backlit regions. In this context, “optimal” means the adjustment, according to an optimization criterion, of the information reproduced by the light-valve raster to the raster of the backlighting arrangement. The adjustment of the information is performed for example by changing the resolution of and/or shifting the display within the light-valve raster. Thus, the controller preferably shifts the to-be-reproduced information in the x- and/or y-direction relative to the originally provided position on the display device and/or changes the size of the to-be-reproduced information, for example by resealing it, that is, the display on the display device is made larger or smaller relative to the originally provided size of the to-be-reproduced information.

Particularly preferably, wide-format cinematic films or other pieces of information whose aspect ratio does not match the aspect ratio of the display device are adjusted, by control of this kind, to the screen format of the display device, particularly to the raster of the light tiles of the light source arrangement. For example, it is possible to adjust the video image in such a way that it falls within the appropriate raster of the light tiles in the x- and/or y-direction. The controller is then preferably suitable for detecting black bands, particularly at the top and bottom edges of the picture, and then turning off the backlighting entirely, where appropriate, in the regions concerned.

In a preferred embodiment, it is provided that the controller adjusts the acceptance angle of the light valves backlit by a light tile to the luminous intensity of the light tile. For example, the controller opens a light valve to a greater extent in the presence of a low luminous intensity than it does in the presence of a higher luminous intensity, so that preferably the brightness of the pixel associated with the light valve is essentially independent of the luminous intensity of the light source that is backlighting the light valve.

A further advantageous embodiment provides that in the case of direct backlighting of the light valves, the controller takes into account the overlap of the emissions from adjacent light sources or light groups as an input variable in an algorithm used to adjust the luminous intensity of the individual light sources or light groups. In this case, direct backlighting means the omission of optical elements between the light sources and the backlit display device, for example the omission of white box elements and/or light guides. If no optical elements are used in backlighting a display device, then cones of light form from the light sources outward and overlap with one another. In one embodiment, this overlap is taken into account by the controller in calculating the adjustment of the luminous intensity of the individual light sources or light groups. For example, the controller preferably operates a light source at lower intensity when pixels that are in the region of the display device being backlit by the light source and that are supposed to have high brightness are also being backlit by an adjacent light source.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of the manner of operation of a first embodiment of a display device according to the invention,

FIG. 2 is a schematic representation of the manner of operation of a further embodiment of a display device according to the invention,

FIG. 3 is a schematic representation of the manner of operation of a third embodiment of a display device according to the invention,

FIG. 4 is a schematic representation of the manner of operation of a fourth advantageous embodiment of a display device according to the invention, and

FIG. 5 is a schematic representation of the structure of a display device comprising light valves.

All the figures shown are schematic and are for purposes of explanation. The elements shown and their size relationships to one another are basically not to be considered true to scale.

### DETAILED DESCRIPTION

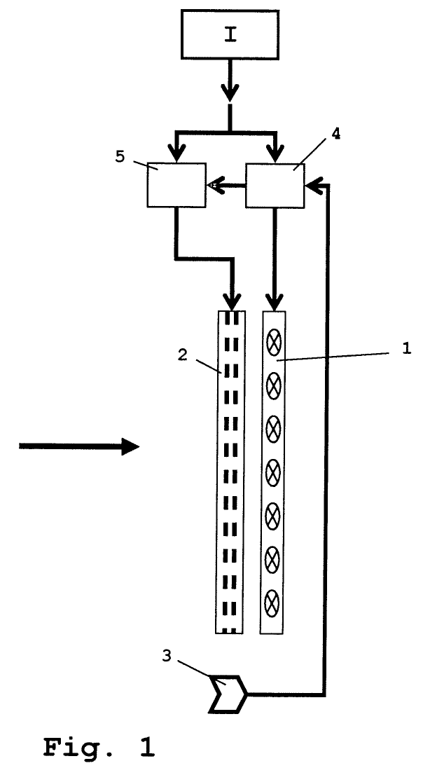

FIG. 1 is the schematic of a first embodiment of a display device. Here, a light valve arrangement 2 and a light source arrangement 1 are used to display or indicate a piece of information I that can be assimilated by an observer. The preferred direction of observation is indicated by an arrow in each of FIGS. 1 to 4.

In this embodiment, a piece of information I to be reproduced is stored in the display device.

Said information I is routed to a controller 4 and a control unit 5. Control unit 5 serves to control the light valves. Such control units 5 are already basically known from conventional display devices comprising light valves. In the embodiment according to FIG. 1, the light source arrangement 1 serving as background illumination for the light valve arrangement 2 is also used, with the aid of controller 4, to reproduce the information I. For this purpose, controller 4 controls the brightnesses of the individual light sources 55 of light source arrangement 1, which are semiconductor light sources in the present case.

The controller 4 extracts one or more of the following pieces of information from the to-be-displayed information signal transmitting the information I to be reproduced to the display device and uses them as input variables for one or more algorithms operative to control the luminous intensity of the individual light sources 55:
the contrast information over the entire area to be displayed—in the present case, the normalized brightness of the brightest pixel and the of darkest pixel of the piece of information I,
the contrast data of one or more regions of the area, each of which is backlit by a single light source or a group of light sources—in the present case, the normalized brightness of the brightest pixel and of the darkest pixel of the piece of information I within this region or these regions,
the corresponding contrast data of the areas or regions illuminated by particular directly adjacent light sources,
where applicable, the one or more above-cited contrast data of the temporally preceding and/or succeeding image, and/or the ambient brightness.

In particular, in displaying a sequence of images, for example a video film or a television signal, the contrast information from a preceding image, or, especially in the case of time-delayed display, also the contrast information from a succeeding image, is used to enhance the contrast of the display of an image in the sequence. Contrast enhancement occurs in that the controller 4 uses one or more algorithms to analyze the input variables extracted from the incoming data and adjusts the brightness of the individual light sources according to a setpoint. The controller 4 preferably contains a microelectronic controller (not shown), which stores the available data, prepares the data according to one or more algorithms, and delivers corresponding control signals.

In this specific embodiment, it is further provided that at least one sensor 3 of the controller 4 supplies additional data concerning the ambient brightness in the region of the display device. These additional data are also analyzed by means of one or more algorithms, and the controller 4 corrects the luminous intensity of the individual light sources accordingly. For example, the controller 4, during operation, preferably increases the luminous intensity of the light sources 55 if the ambient brightness is high. Particularly preferably, one or more brightness sensors (ambient light sensors) are used to determine the ambient brightness. Ambient light sensors are sensors whose sensitivity spectrum is preferably optimized to the sensitivity of the human eye, hence the eye of the observer.

In the embodiment depicted in FIG. 1, the controller 4 additionally influences the control unit 5, as indicated by a causality arrow. The controller 4 in this case influences the resolution of the to-be-reproduced piece of information I passed along by the control unit 5 to the light valve arrangement 2. Such influencing of resolution is particularly advantageous because the raster of the light valve arrangement 2 does not match the raster of the light source arrangement 1 in the present case. The raster of light valve arrangement 2 is finer than that of light source arrangement 1. Whereas in conventional display devices the resolution is defined by the control unit 5 alone, optimal and uniform assignment of the light valves of light valve arrangement 2 to the raster of light source arrangement 1 is achieved by adjusting the resolution in a manner that is defined by the controller 4.

Resolution with optimal assignment is to be understood in this context as meaning, for example, that the envelope of the area formed by the light valves used for display, when projected onto the light source arrangement 1, does not cut across any regions that are backlit by individual light sources, but always coincides with their boundaries. The resolution is therefore adjusted in such a way that the reproduction area determined by this means is, in the ideal case, congruent with an area formed from light tiles of the backlighting arrangement. In other words, the total number of pixels per row is preferably a whole multiple of the number of pixels per row of a light tile, and/or the total number of pixels per column is a whole multiple of the number of pixels per column of a light tile.

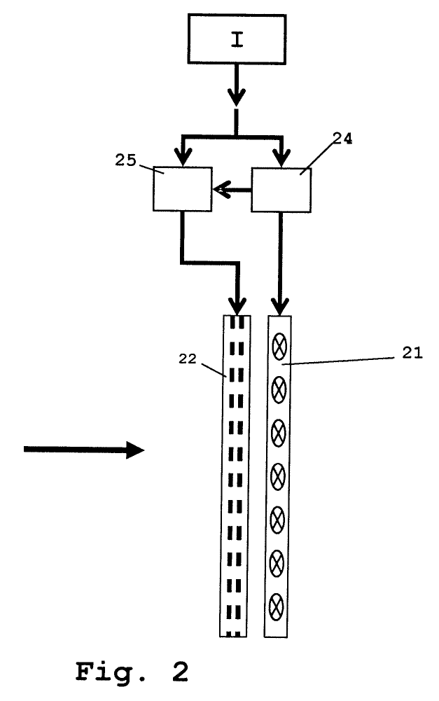

FIG. 2 shows a further advantageous embodiment of a display device according to the invention. A piece of information I to be reproduced is stored in the display device. Said information is routed to a controller 24 and a control unit 25, the controller 24 being provided to act on the control unit 25. The embodiments according to the invention are not, however, limited to the condition that the controller 24 and the control unit 25 or their equivalents are implemented separately in the other embodiments, but rather, the two can be implemented jointly as an integrated unit. Control unit 25 controls light valve arrangement 22, while controller 24 drives light source arrangement 21.

An observer registers the light emanating from light source arrangement 21 and impressed by light valve arrangement 22 with the piece of information I to be reproduced.

In this exemplary embodiment, the controller 24 uses one or more of the pieces of information or input variables described in connection with FIG. 1 to control the brightness of the individual light sources 55 of light source arrangement 21. In contradistinction to FIG. 1, here no brightness sensor is provided.

The raster of the light source arrangement 21 is created by individual light sources 55 backlighting subregions of the light source arrangement. These subregions or light tiles, in combination, form the backlighting arrangement for the area. The number of light tiles in the present case is smaller than the number of light valves. The light source arrangement and the light valve arrangement consequently have different rasters. It is therefore advantageous to change the resolution, by having the controller 24 influence the control unit 25. Changing the resolution of the information is especially advantageous if it results in whole light tiles of the light source arrangement 21 being used for backlighting in order to display the information by means of the light valve arrangement 22. In other words, the resolution is adjusted in such a way that the edge of the resulting display, projected onto the light source arrangement 21, exactly meets the edges of individual light tiles.

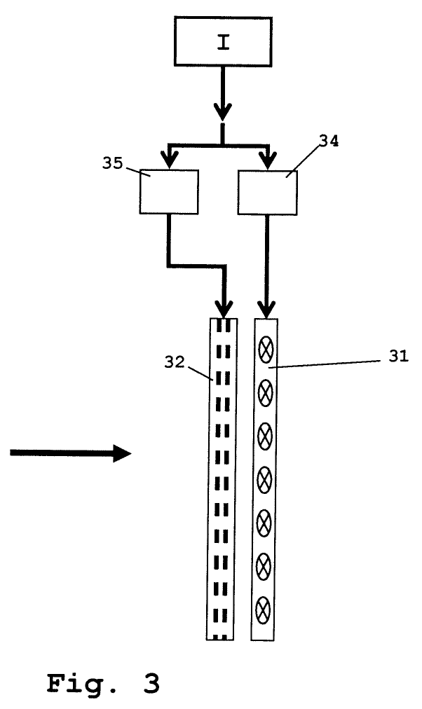

FIG. 3 shows a third embodiment of a display device. In this embodiment, information I to be reproduced is stored in the schematically depicted display device. The information is routed to the controller 34 and the control unit 35. The control unit 35 analyzes the information and drives the light valves of light valve arrangement 32 accordingly. The controller 34 extracts one or more of the above-described contrast data from the information I to be reproduced and analyzes them. It uses for this purpose one or more algorithms of the kind described in conjunction with the exemplary embodiments according to FIGS. 1 and 2.

In dependence on the contrast data analyzed by means of one or more algorithms, controller 34 controls the brightness of the individual light sources of light source arrangement 31, which are semiconductor light sources in the present case.

Since the contrast data generally are normalized brightness data, further advantageous embodiments of the invention process the corresponding brightness data, instead of the aforementioned contrast data, as input data.

As an effect of controller 34, the observer sees a display of the information displayed by means of light valve arrangement 32 in which the contrast has been enhanced by the driving of light source arrangement 31.

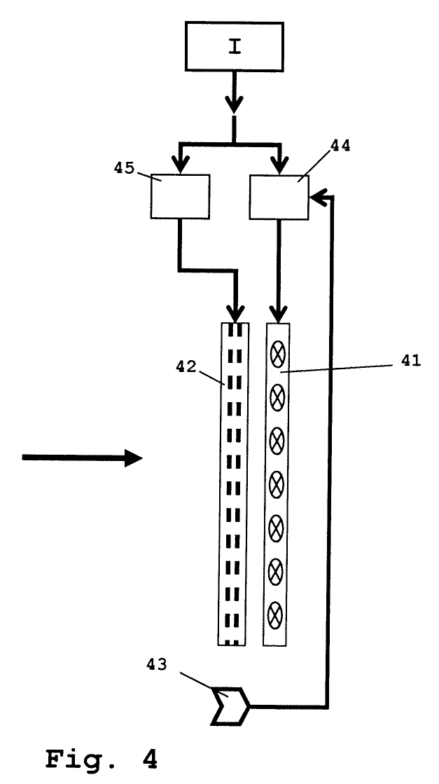

FIG. 4 shows a fourth embodiment of a display device, in which the information I to be reproduced is stored in the system. The information I is routed to a controller 44 and a control unit 45. Embodiments according to the invention are not, however, limited to the condition that control unit 45 and controller 44 must be separately implemented, but instead include in particular the possibility of integrating controller 44 and control unit 45 jointly in an overall control system.

Control unit 45 serves to drive light valve arrangement 42. Controller 44 uses one or more algorithms to analyze input variables, from which the information I is extracted.

The input variables can be brightness and/or contrast data of the stored information to be reproduced, as described in the preceding exemplary embodiment. In addition, a controller 44 can receive as input variables, and analyze, the data from at least one sensor 43 measuring the ambient brightness of the room in which the display device is being operated.

The analysis is performed using one or more of the previously described algorithms. A driving of the light sources 55 of light source arrangement 41 is effected as a result of this analysis. In that operation, the brightness of individual light sources is preferably varied to enhance the contrast of the display as a whole. Alternatively, it is possible to vary the brightness of groups of light sources, for example individual rows or columns of light sources. The controller thus controls the luminous intensity or the brightness of individual light tiles or the brightness of groups of light tiles, for example of the rows or columns of the raster formed by the light tiles.

By selectively analyzing the incoming data, the controller 44 therefore produces a contrast enhancement of the reproduced information that can be perceived by an observer.

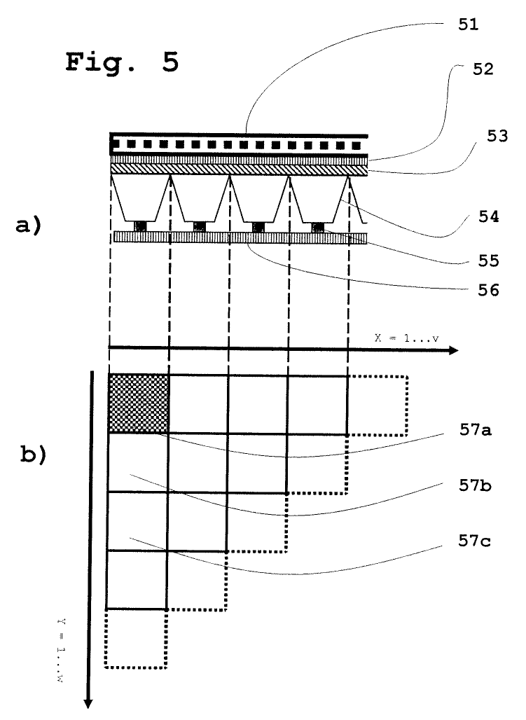

FIG. 5 shows the schematic structure of a display device comprising light valves. FIG. 5a is a schematic cross section of the structure of such a display device, and FIG. 5b is a schematic plan view of such a display device.

In FIG. 5a, several light sources 55—here, semiconductor light sources—are disposed on a carrier 56. The light sources 55 are preferably light groups, such that one light source 55 encompasses a plurality of light-emitting semiconductor components, which are, particularly preferably, disposed in a common housing. The carrier 56 in the present case is a circuit board, particularly a metal-core circuit board. Because of their relatively high thermal conductivity, metal-core circuit boards permit especially efficient cooling of the light sources 55. The light sources 55 couple their radiated light into homogenizing elements, so-called white box elements, 54. The dimensioning of the white box elements on their respective light exit sides determines the size of the light tiles in this exemplary embodiment. These white box elements include reflectors for beam-shaping. The reflectors in the present case are shaped such that the entire light exit side of each light tile radiates light as uniformly as possible when the light source is in operation.

The relationship between the dimensions of the respective light exit sides of the white box elements and the size of the light tiles is visualized by means of the broken lines connecting FIGS. 5a and 5b. In this case, disposed after the light sources or light groups, on the light exit side, are a diffuser 53 and at least one BEF (brightness enhancement film) 52. The diffuser 53 sees to the homogenization of the radiated light. The BEF 52 serves to improve the radiation characteristic of the display device by focusing the radiation in the direction of the observer, and is available commercially from the 3M company, for example. Disposed after this backlighting system is a light valve arrangement 51, which modulates a piece of information onto the radiated light. Such a light valve arrangement usually has a multilayer structure and usefully comprises a plurality of filters, for example polarization filters.

The schematic structure of the display device is illustrated in plan in FIG. 5b. The backlighting of the display device is composed of individual light tiles 57a, 57b, 57c. Numbers v and w of light tiles are arranged in the x- and y-directions, respectively, to backlight the radiation exit surface of the display device. The number v, w of light tiles is usefully adapted to the size of the display device. The light valve arrangement 51 disposed after the light tiles is depicted only within light tile 57a in FIG. 5b, and is indicated schematically by a checkerboard pattern. In this exemplary embodiment, the raster of light valve arrangement 51 is finer than the raster of the light tiles.

Particular embodiments of the invention provide that the display device is, for example, a 32″ TFT television set. In that case, assuming a 16:9 picture format, the light valve arrangement has a pixel resolution of 1366×768 pixels or more. This light-valve raster is backlit by an arrangement of light tiles. This light tile arrangement includes, for example, 22×12 (v×w) light tiles, i.e., 264 light tiles in all. These light tiles preferably contain, as light sources, LEDs with the product name MultiLED or Advanced Power TopLED or light groups constructed therefrom. In this exemplary embodiment, therefore, each light tile backlights a region of approximately 64×64 pixels of the light valve arrangement.

Alternatively, the display device can also be backlit by 43×24 (v×w), i.e. 1032, light tiles, each of which contains, for example, one Power TopLED. Thus, each set of about 32×32 pixels of the light valve arrangement is backlit by one light tile, each of which comprises, for example, one Power TopLED.

MultiLED, Power TopLED and Advanced Power TopLED are names of semiconductor light sources sold by the Osram company.

In a further advantageous embodiment, the display device includes a 45-inch TFT screen. In the case of a 16:9 picture format, the light valve arrangement therefore has a pixel resolution of 1920×1080 pixels. Here, for example, 30×17 (v×w), i.e. 510, light tiles are used for backlighting, each of which preferably contains as a light source a MultiLED or an Advanced Power TopLED. In this particular exemplary embodiment, each light tile then backlights a respective region of the light valve arrangement containing about 64×64 pixels.

Additional embodiments are within the scope of the following claims.

What is claimed is:

1. A light source arrangement for backlighting a display device, comprising a plurality of light sources and a controller that adjusts the luminous intensity of individual light sources or of groups of light sources based on information to be reproduced.

2. The light source arrangement as in claim 1, wherein said light sources include at least one radiation-emitting semiconductor component.

3. The light source arrangement as in claim 2, wherein each said light source includes a plurality of radiation-emitting semiconductor components.

4. The light source arrangement as in claim 1, which contains a light valve arrangement particularly comprising a plurality of light valves.

5. The light source arrangement as in claim 4, wherein one of the light sources backlights a region with a plurality of light valves.

6. The light source arrangement as in claim 1, wherein said controller controls the luminous intensity of said light sources by clocking the power supply.

7. The light source arrangement as in claim 1, wherein said controller controls the luminous intensity of said light sources by varying their operating current.

8. The light source arrangement as in claim 1, wherein said light sources are arranged in rows and columns.

9. The light source arrangement as in claim 8, wherein said controller controls the luminous intensity of said light sources by rows and columns.

10. The light source arrangement as in claim 1, wherein said light sources are arranged according to a regular grid.

11. The light source arrangement as in claim 10, wherein said grid has rectangular, parallelogrammatic, hexagonal or rhombic basic units.

12. The light source arrangement as in claim 1, wherein at least one diffuser is disposed after said light sources in the radiation direction.

13. The light source arrangement as in claim 1, wherein a homogenizing element and/or a light guide is disposed after said light sources in the radiation direction.

14. The light source arrangement as in claim 1, wherein a BEF (brightness enhancement film) is disposed after said light sources in the radiation direction.

15. The light source arrangement as in claim 1, wherein said light sources are disposed on a common carrier.

16. The light source arrangement as in claim 1, wherein said controller is configured to operate at different luminous intensities, at the same times, light sources that backlight different regions of said display device.

17. The light source arrangement as in claim 1, wherein said controller is adapted to influence the luminous intensities of said light sources in dependence on at least one of the following input variables:
contrast values within the backlit region of a said light source,
contrast values of the backlit regions of adjacent said light sources,
contrast values of the information reproduced by said display device,
ambient brightness.

18. The light source arrangement as in claim 1, wherein in the case of the reproduction of an image sequence said controller is configured to vary the luminous intensity of the individual light sources or groups of light sources in dependence on the contrast values of one image or plural images in said image sequence.

19. The light source arrangement as in claim 1, where said controller additionally drives said light valve arrangement in order to adjust the graphic resolution of the reproduced information.

20. The light source arrangement as in claim 1, wherein in the case of direct backlighting, said controller is configured to account for overlap of the emissions from adjacent light sources when adjusting the luminous intensity of the individual light sources.

21. A display device comprising a light source arrangement as in claim 1.

22. The display device as in claim 21, comprising an LCD or TFT screen.

23. The light source arrangement of claim 15, wherein the common carrier is a circuit board.
